(19) United States
(12) Patent Application Publication
(10) Pub. No.: US 2007/0114073 A1
(43) Pub. Date: May 24, 2007

(54) Capacitive sensor to detect a finger for a control or command operation

(75) Inventors: Dominique Akel, Paris (FR); Stephane Lomp, Bercheres Saint Germain (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: JAEGER CONTROLS, Chartres Cedex (FR)

(21) Appl. No.: 11/585,452

(22) Filed: Oct. 24, 2006

(30) Foreign Application Priority Data
Oct. 28, 2005 (FR) 05 53 282

(51) Int. Cl. G08C 21/00

(52) U.S. Cl. 178/18.06

(57) ABSTRACT

A capacitive sensor to detect a finger for an operation of a control and/or command comprises an electrically insulating layer forming a detection surface fitted with position marks for application of a finger, and generation of a signal by positioning or movement of the finger. A capacitive layer is covered by an insulating layer and formed by a stack of alternating conductive sections and non-conductive sections placed on edge. At least some conductive layers are linked to elementary contacts to form parts of capacitors distributed in cells. The capacitance of all capacitors of a cell is added together in the signal supplied by the cell. A processing circuit linked to the cell connectors of the capacitive cells receives the capacitive signals to evaluate and compare them, and to establish whether they correspond to the presence of a finger, and to determine the nature of the finger.

### FIELD OF THE INVENTION

The present invention concerns a resilient longitudinal capacitive sensor which can assume different forms to detect a fingerprint or finger diameter for a control/command operation.

### PRIOR ART

There are capacitive controls functioning on the all-or-nothing principle i.e. in binary logic, which control the start or stop of a generally electrical appliance.

Precisely because of the application of such capacitive controls, the means for their implementation are generally of relatively large dimensions similar to the size of a fingerprint. Such sensitive controls functioning by capacitive effect are for example used to control lifts or other equipment of this type; allocated to each floor and more generally to each function of the lift is a sensitive key that is activated by simple contact of a finger. But such keys do not allow progressive control owing to the size of the space taken up by the sensor.

### OBJECT OF THE INVENTION

The object of the present invention is to develop a sensitive sensor allowing progressive control of the function with which it is associated, for example the control of an electrical device for which the user wishes to control the power consumed/supplied, such as for example an electric hob, the temperature of an oven, the temperature of a radiator or other appliances of this type.

The sensor must allow a non-constraining detection i.e. in relation to the control functions it must perform. Thus it must be able to receive the mark of a finger without requiring positioning with obligatory great precision of the finger on the face of the detection surface. It must also allow, in addition to and after the control, performance of a command for example the starting of a device or the control of the operating power thereof by interpreting the movement of the finger as simulating the movement of a cursor.

### EXPLANATION AND ADVANTAGES OF THE INVENTION

To this end the invention concerns a capacitive sensor of the type defined above, characterised in that it comprises:
A) an electrical insulating layer forming a detection surface fitted with position references for application of the finger and generation of a signal by positioning or movement of the finger,
B) a capacitive layer covered by the insulating layer and formed by a stack of alternating conductive and non-conductive sections placed on edge, at least some of the conductive layers being linked to elementary contacts to form parts of capacitors distributed in cells, the elementary contacts being connected in parallel to a cell connector, an elementary capacitor being completed by the surface of the finger applied to the insulating layer to form a capacitor, the capacitance of all capacitors of a cell being added together in the signal supplied by the cell,
C) a processing circuit to which are linked the cell connectors of the capacitive cells and which receives the capacitive signals to evaluate and compare them and to establish whether they correspond to the presence of a finger and determine the nature of the finger.

A capacitive sensor according to the invention is intended to detect a finger for an operation of control or command of a device, for example to authorise use of a domestic electrical appliance in order to prevent this being started by a child. The capacitive sensor is not intended to recognise a fingerprint but must simply be able to distinguish an adult's finger from a small child's finger. This distinction is based on the area of contact between the finger applied to the sensor detection surface, determining whether it belongs to a child or an adult. The capacitive sensor must also not be able to be misled by the outline of several fingers applied to the detection surface which could be interpreted as corresponding to the area of an adult finger.

This capacitive sensor of reduced dimensions and space requirement, which can easily be integrated into a control panel or controlled appliance, allows not only the sending of a start or stop signal but also the sending of a large number of signals as a function of the mode of action of the finger on the capacitive sensor, either as the position of the finger at a particular marked location of the capacitive sensor or a movement between two or more positions.

Such a capacitive sensor is advantageously used to control a hot plate, for example to adjust its temperature or cooking power.

This capacitive sensor, placed beneath a glass type insulator, has the advantage of ensuring complete electrical isolation between the equipment with which it is associated and the user. Such isolation is particularly useful for applications between kitchen appliances or similar situations as the user can control the electrical device even with wet fingers without risking the sudden tripping of an electrical protection such as a circuit breaker or without electrical risk to himself in the case of inadequate or defective electrical protection of the equipment.

The control can be all-or-nothing i.e. stop/start. The control can also be associated with a progressive adjustment similar to the function of a cursor, for example by movement of the finger along the detection surface of the sensor.

The change in setting is monitored on a screen (for example the reference temperature) which changes by simple movement in one direction or the other of the finger on the sensor.

The sensor allows not only generation of a control signal for a particular function but also ensures protection of use in relation to children. This is important for kitchen appliances such as hot plates, ovens or equipment of this type. The sensor can in fact, by its design and processing, detect the diameter of control element on the sensor. In the case of insufficient area corresponding to the placing of a child's finger on the sensor, the system will refuse access to the function to be controlled.

According to an advantageous feature, the detection surface comprises an insulating plate. This insulating plate can comprise markings or references for activation of the sensor such as a power indication.

Advantageously the stack of conductive and non-conductive layers is constituted by an elastomer segmented by conductive layers.

The conductive layers are advantageously formed by a carbon-loaded elastomer.

According to another advantageous feature, the processing circuit uses only the signals from adjacent cells.

According to another advantageous feature, the elementary contacts are joined within the connector which covers and touches a succession of conductive layers of a cell.

According to another advantageous feature, the cell connectors are identical.

According to another variant the cell connectors have an identical area.

### DRAWINGS

The present invention will be described below in more detail with reference to various embodiments of a capacitive sensor according to the invention shown in greatly enlarged scale in the attached drawings in which:

FIG. 1 is a general view of the capacitive sensor according to the invention,

FIG. 2A is a partial top view of one embodiment of the sensor,

FIG. 2B is a cross-section view of the sensor in FIG. 2A,

FIG. 2C is an equivalent diagram of the sensor in FIGS. 2A and 2B,

FIG. 3A is a partial top view of another embodiment of the sensor,

FIG. 3B is a partial cross-section of the sensor in FIG. 3A,

FIG. 4A is a partial top view of another embodiment of the sensor according to the invention,

FIG. 4B is a top view of an elementary connector of a cell of the sensor in FIG. 4A.

### DESCRIPTION OF AN EMBODIMENT

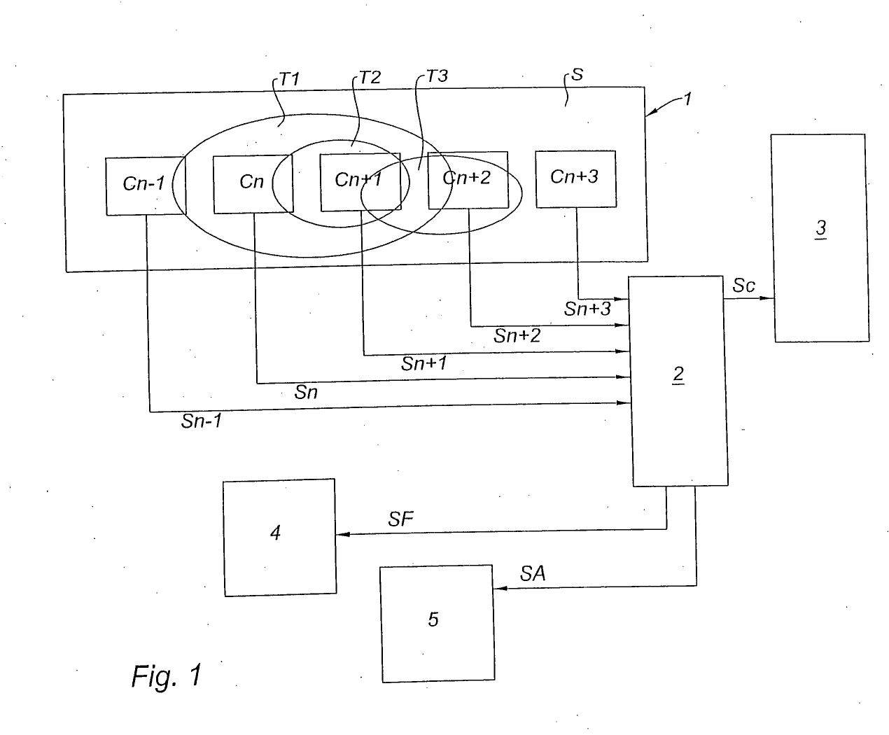

In the diagrammatic cross-section view in FIG. 1, the invention concerns a sensor intended to allow the monitoring or emission of a control signal of the all-or-nothing or progressive type in order to control a device, in particular an electrical device such as a kitchen appliance which functions simply by starting or stopping, or an apparatus able to function in a regulated manner following a fixed or selected programme or a progressive command, such as for example a hot plate, an oven, a washing machine or a dishwasher, a lighting dimmer, or a boiler temperature control system. Multiple other applications are possible.

The sensor 1 comprises a detection surface S on which the finger is applied in a defined procedure: simple touch, holding of the finger for a variable period defining an operating parameter of the device controlled in order to generate the control signal by all-or-nothing or continuous adjustment. This detection surface S is fitted with markings for positioning the finger at a fixed location or markings constituting the limits of movement of the finger corresponding to adjustment ranges. Several locations can also be combined with different functions, some serving for all-or-nothing adjustment and others for progressive adjustment. Sensor 1 is linked to a processing circuit 2 which uses its signal to form the control signal SC intended for the device to be controlled 3, and where applicable an operating signal SF and a display signal SA.

The operating signal SF controls a generator 4 emitting a sound, a voice message or light signal to confirm that the finger DG has indeed actuated the sensor 1 or to indicate the function commanded.

The display signal SA is sent to a display 5 which indicates the correct use of the sensor 1 in parallel with or instead of the signal emitted by the generator 4, by directly displaying information confirming the functioning of sensor 1 and the input of the signal by the finger DG.

The display 5 shows the operating information requested by action of the finger on the sensor:

the start or stop of the device 3,

the function programme selected,

the menu for selection of an operating mode,

the operating parameter of the device 3.

The processing circuit 2 not shown in detail comprises computer processing means and/or circuits, in particular electronic, to process the signal supplied by the sensor 1, to recognise, validate and interpret it and to generate the control signal SC and where applicable signals SF and SA.

In more detail, the capacitive sensor 1 comprises a detection surface S marked by a rectangle, within which are the capacitive cells Cn (n=1 . . . ) arranged in a certain orientation, for example aligned. These capacitive cells Cn each supply a detection signal Sn, the totality of which constitutes the global signal of the sensor applied to the processing circuit 2. This analyses the signals Sn, compares them with references and as a function of this analysis, emits the control or validation signal Sc to control the device 3, the display signal Sa for the display 5 or signal SF for generator 4.

The signal Sn of the capacitive cell Cn depends on the area covered by the outline of the finger. FIG. 1 shows three examples of finger outlines T1, T2, T3 depending on whether the finger is pressed hard or lightly on the detection surface, and the size of the finger.

Thus outline T1 totally covers the capacitive cells Cn, Cn+1 and only partially cells Cn−1 and Cn+2. Signals Sn, Sn+1 and Sn−1, Sn+2 sent to the processing circuit 2 indicate this situation.

In the case of outline T2 representing the action of a small finger or a finger lightly applied, only cell Cn+1 is virtually covered by the outline whereas cell Cn is only half covered. The other cells are not covered.

In the case of outline T3, cell Cn+2 is practically covered while cell Cn+1 is only covered over less than half its area. The cells not covered by an outline give no signal or a zero signal. As the circuit 2 receives the global signal formed by signals Sn of each cell Cn, it can mark the position of the finger thanks to the zero signals between which are the non-zero signals representative of the outline of the finger. In the present example outline T3 gives non-zero signals Sn+1, Sn+2 lying between firstly zero signals Sn−1, Sn and secondly the zero signal Sn+3.

The processing circuit 2 applies assessment criteria to signals Sn, taking them into account separately or globally. First it verifies that the signals received indeed correspond to adjacent capacitive cells and that there is no significant free interval between the cells so as to avoid interpreting two small non-adjacent outlines as representing the outline of a large finger.

Another assessment criterion is that of the area of the outline detected. This area is compared with a minimum threshold representing the difference between the outline of a child's finger and that of an adult's. Various other plausibility criteria can also be applied, for example an upper threshold to avoid an outline other than that of a finger being interpreted as the outline of a finger.

As well as this static outline monitoring, the processing circuit 2 can also perform a dynamic monitoring and deduce therefrom information and control signals.

Thus depending on the function of the capacitive sensor, this is not only intended to detect and verify the outline of a finger but also to receive instructions transmitted in the form of finger outlines. It can verify the movement of the outline over the capacitive cells in the manner of the movement of a cursor to generate a control signal, for example for the intensity of function of a device or a signal for the operating level of the device (rotation speed, adjustment of temperature or duration).

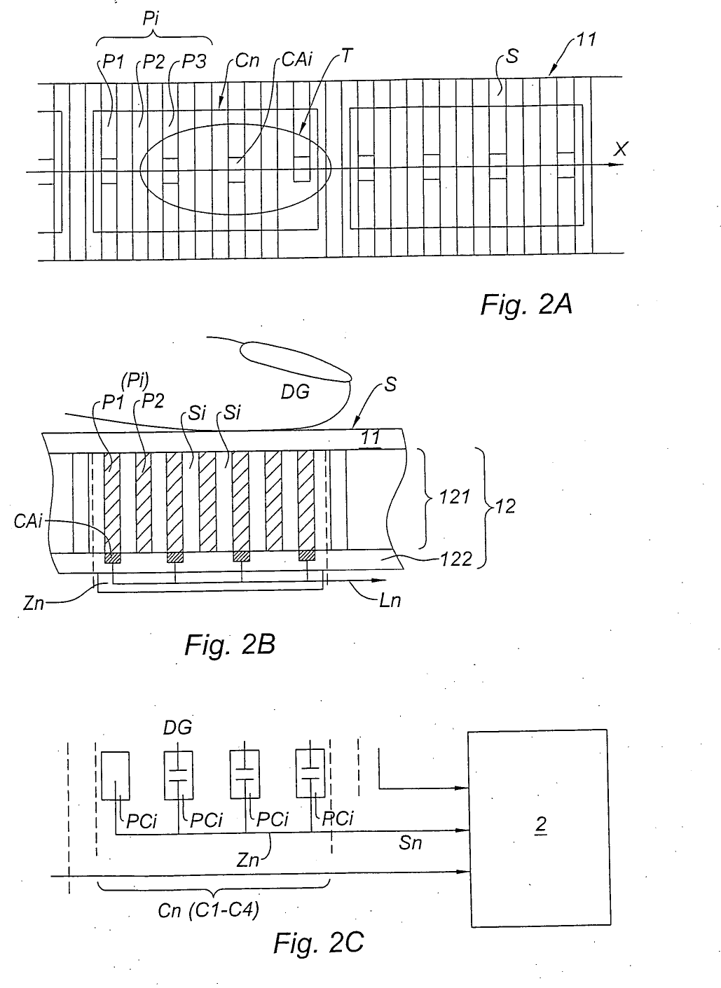

FIGS. 2A-2C show in more detail and on enlarged scale the structure of the capacitive sensor 1 comprising an electrical insulating layer 11 covering a capacitive layer 12 linked to a processing circuit 2.

The electrical insulating layer 11 forms the detection surface S against which is applied the finger to be detected. This detection surface is fitted with position markings for example represented by rectangles corresponding to the capacitive cells Cn. The electrical insulating layer 11 can be a layer of glass or other electrically insulating material.

According to FIGS. 2A, 2B, the capacitive layer 12 is a stack 121 formed of alternating conductive sections Pi and non-conductive sections Si and the conductive sections Pi (P1, . . . , P5) are indicated with hatching. This stack 121 is placed on its edge i.e. the top of the sections is below the insulating layer 11 and the bottom comes to rest on a support and connection surface, for example a printed circuit board 122 comprising contacts CAi touching certain of the conductive sections Pi. Although FIG. 2B shows elementary contacts CAi associated with precisely one conductive section, such precision is not necessary and in reality the elementary contact CAi covers several conductive layers without this modifying the result of the global signal analysis.

Contacts CAi extend only over part of the length of the section (dimension taken perpendicular to the plane of FIG. 2B such that in top view, these elementary contacts CAi appear in the form of rectangles in FIG. 2A).

FIG. 2B shows such elementary connectors CAi linked to sections P1, P3, P5, P7 while the intermediate conductor sections P2, P4, P6 are not brought into contact. Conductive sections Pi form parts of capacitor PCi. All sections Pi touching contacts CAi are linked to the same cell connector Zn which has an output line Ln linked to the processing circuit 2.

This cell connector Zn and the associated conductive sections Pi form a capacitive cell Cn. Different capacitive cells Cn (n=1 . . . ) succeed each other in the capacitive sensor, for example following a rectilinear alignment as shown in the top view in FIG. 2A. The cell is delimited in FIG. 2B by two vertical dotted lines.

Contacts CAi and cell connector Zn are preferably produced in the form of a printed circuit carrying the stack 121 and the components such as the processing circuit 2, the generator 4 and the display 5.

FIG. 2C shows the equivalent diagram of a capacitive cell Cn and the parts of capacitor PCi each comprising a conductive section P1, P3, P5 etc. and the cell connector Zn combining all parts of the capacitor thus shown. In this example there are four parts of capacitor PCi (i=1-4).

When a finger DG is applied to the detection surface S of the insulating layer 11 as shown in FIG. 2B (outline T of finger DG is shown on FIG. 2A), the finger with the insulating layer 11 and the capacitor parts PCi forms capacitors C2, C3, C4 of finite capacitance since the conductive sections P3, P5, P7 are covered by finger DG whereas section P1 is not in contact with the finger.

Under these conditions the part of capacitor PC1 has an infinite value such that the inverse of its capacitance is a zero value. By addition of the capacitances of the capacitors of cell Cn, we obtain a signal Sn representing the finite capacitances C2, C3, C4. Thus the signal is representative of the outline T of finger DG on the detection surface of the sensor. It is used by the processing circuit 2 as shown above.

This signal is only representative of the length of the finger outline TR which may be sufficient. However it is preferable to associate therewith a criterion representative of the width of the finger outline.

For the purposes of description of the invention, the capacitive sensor has been shown on a greatly exaggerated scale in particular for the dimension of the capacitive cells P2. In general an adult finger outline covers two to three capacitive cells and conductive sections. In fact these sections are extremely thin to allow good resolution. Furthermore and as will be seen later, a capacitive cell can have not only a dimension in direction XX but also a transverse dimension in direction YY.

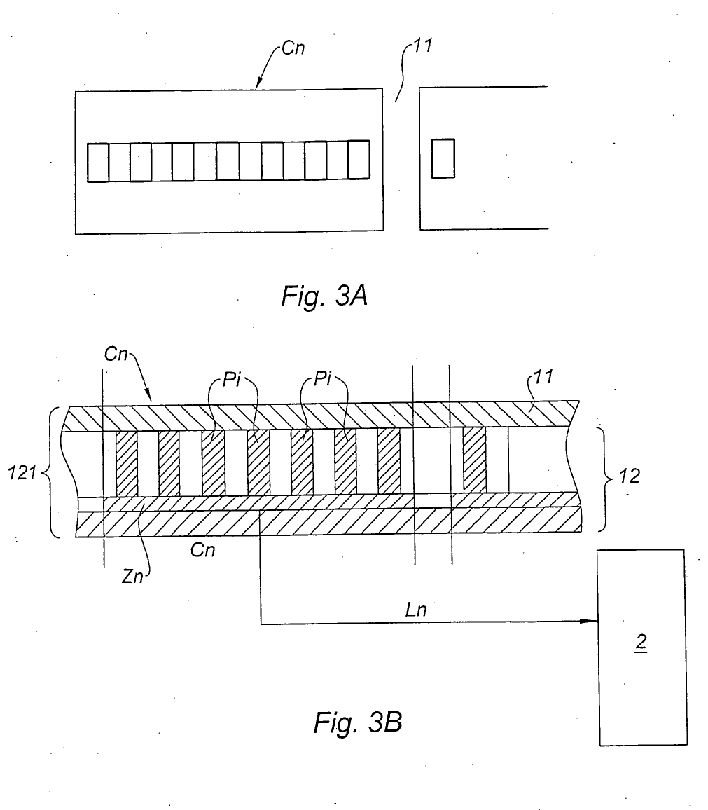

FIGS. 3A, 3B show another embodiment of the invention represented by just one capacitive cell Cn, in top view and in cross-section. These figures emphasise the embodiment of the cell connector Zn in the form of a longitudinal bar (direction XX) covering a certain width of sections Pi of the stack associated with a capacitive cell. The width covered by the elementary connector Zn gives in top view rectangular contact areas between the conductive sections Pi of stack 121 (these sections are shown in FIG. 3B but not in FIG. 3A) and the elementary connector Zn. The elementary connector Zn of cell Cn is linked by line Ln to the processing circuit 2.

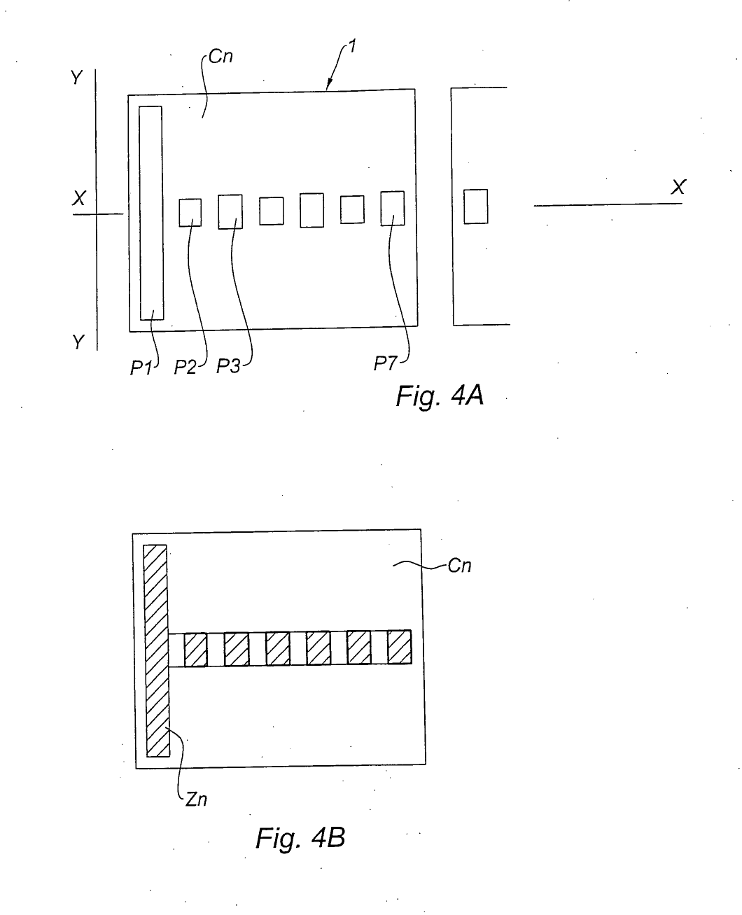

FIGS. 4A, 4B show another embodiment of a capacitive cell Cn of a sensor 1 according to the invention. This cell Cn ensures detection in two directions, the direction of axis XX and the transverse direction YY. For this the cell connector Zn has the form of a lying T, the contour of which appears in the top view in FIG. 4B.

FIG. 4A shows only the contact areas between the conductive sections Pi and the cell connector Zn. The first conductive section Pi has a large contact area extending in the transverse direction YY whereas the other conductive sections P2, . . . , P7 have relatively reduced contact areas like those already described above. Under these conditions the capacitance of the capacitor associated with the first conductive section will be much greater if this section is fully covered by the finger outline than the capacitance associated with the other different conductive sections. The processing circuit recognises this form of elementary connector and interprets the capacitance of the capacitive cell as a function of the potential capacitance.

Other forms of cell connector can also be considered with larger parts distributed in the elementary cell.

1. Capacitive sensor to detect a finger for operation of a control or command, comprising
A) an electrical insulating layer forming a detection surface fitted with position references for application of a finger and generation of a signal by positioning or movement of the finger,
B) a capacitive layer covered by the insulating layer and formed by a stack of alternating conductive sections and non-conductive sections placed on edge, at least some of the conductive layers being linked to elementary contacts to form parts of capacitors distributed in cells, the elementary contacts being connected in parallel to a cell connector, a part of the elementary capacitor being completed by the surface of the finger applied to the insulating layer to form a capacitor, the capacitance of all capacitors of a cell being added together in the signal supplied by the cell,
C) a processing circuit to which are linked the cell connectors of the capacitive cells and which receives the capacitive signals to evaluate and compare them and to establish whether they correspond to the presence of a finger, and to determine the nature of the finger.

2. Capacitive sensor according to claim 1, wherein the processing circuit uses only signals from adjacent cells.

3. Capacitive sensor according to claim 1, wherein the electrical insulating layer comprises a plate of glass or a layer of an electrically insulating material.

4. Capacitive sensor according to claim 1, wherein the stack of alternating conductive sections and nonconductive sections of the capacitive layer forming the connection element comprises an elastomer segmented by conductive sections.

5. Capacitive sensor according to claim 1, wherein the elementary contacts are merged in the cell connector which covers and touches a succession of conductive layers of a cell.

6. Capacitive sensor according to claim 5, wherein the cell connector has a longitudinal extension and a transverse extension in a cell.

7. Capacitive sensor according to claim 5, wherein the cell connectors are identical.

8. Capacitive sensor according to claim 5, wherein the cell connectors have an identical surface area.
